(19) United States
(12) Patent Application Publication
(10) Pub. No.: US 2025/0142592 A1
(43) Pub. Date: May 1, 2025

(54) METHODS AND APPARATUSES FOR SIDELINK TRANSMISSION ON UNLICENSED SPECTRUM

(71) Applicant: Lenovo (Beijing) Limited, Beijing (CN)

(72) Inventors: Xiaodong Yu, Beijing (CN); Zhennian Sun, Beijing (CN); Yu Zhang, Beijing (CN); Haipeng Lei, Beijing (CN); Xin Guo, Beijing (CN)

(73) Assignee: Lenovo (Beijing) Limited, Beijing (CN)

(21) Appl. No.: 18/836,695

(22) PCT Filed: Feb. 8, 2022
(86) PCT No.: PCT/CN2022/075515

§ 371 Date: Aug. 7, 2024

(51) Int. Cl. H04W 72/25; H04W 24/10

(52) U.S. Cl. CPC H04W 72/25; H04W 24/10

(57) ABSTRACT

Embodiments of the present disclosure relate to methods and apparatuses for sidelink (SL) transmission on unlicensed spectrum. According to an embodiment of the present disclosure, a user equipment (UE) can include: a processor configured to: determine a listen before talk (LBT) type of a first LBT operation for an SL transmission on an unlicensed spectrum; and perform the first LBT operation; a transmitter coupled to the processor and configured to: transmit first information associated with the first LBT operation in sidelink control information (SCI) when the first LBT operation is successful; and a receiver coupled to the processor.

### TECHNICAL FIELD

Embodiments of the present application are related to wireless communication technology, and more particularly, related to methods and apparatuses for sidelink (SL) transmission on unlicensed spectrum.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

3GPP 5G networks are expected to increase network throughput, coverage and reliability and to reduce latency and power consumption. With the development of 3GPP 5G networks, various aspects need to be studied and developed to perfect the 5G technology. Currently, details regarding SL transmission on unlicensed spectrum need to be further discussed in 3GPP 5G technology.

### SUMMARY OF THE APPLICATION

Embodiments of the present application at least provide a technical solution for SL transmission on unlicensed spectrum.

According to some embodiments of the present application, a first UE may include: a processor configured to: determine a listen before talk (LBT) type of a first LBT operation for an SL transmission on an unlicensed spectrum; and perform the first LBT operation; a transmitter coupled to the processor and configured to: transmit first information associated with the first LBT operation in sidelink control information (SCI) when the first LBT operation is successful; and a receiver coupled to the processor.

In some embodiments of the present application, the first information associated with the first LBT operation indicates at least one of: the LBT type of the first LBT operation; or a remaining channel occupancy time (COT) associated with the first LBT operation.

In some embodiments of the present application, the receiver is configured to receive downlink control information (DCI) scheduling the SL transmission, and the processor is configured to determine the LBT type of the first LBT operation based at least in part on the DCI.

In some embodiments of the present application, the DCI includes a first indication indicating an LBT type for the first UE.

In some embodiments of the present application, the DCI further includes a second indication indicating the first UE to determine the LBT type of the first LBT operation based on the first indication or based on the first UE's own determination.

In some embodiments of the present application, the DCI includes an indication indicating the first UE to report a result of the first LBT operation regarding whether the first LBT operation is successful or not.

In some embodiments of the present application, the DCI includes an indication indicating a physical uplink control channel (PUCCH) resource for the first UE to report a result of the first LBT operation regarding whether the first LBT operation is successful or not, and the transmitter is further configured to transmit the result of the first LBT operation based on the indication.

In some embodiments of the present application, the indication indicates a time gap between a time slot in which the DCI is received and a time slot for reporting the result of the first LBT operation or a time gap between a time slot in which the SL transmission is performed and a time slot for reporting the result of the first LBT operation.

In some embodiments of the present application, the processor is further configured to obtain configuration information configured or pre-configured to the first UE, the configuration information includes one or more configurations, and each configuration indicates an offset from a time slot in which the DCI is received to a time slot for reporting the result of the first LBT operation or an offset from a time slot in which the SL transmission is performed to a time slot for reporting the result of the first LBT operation; wherein the indication indicates one configuration of the one or more configurations.

In some embodiments of the present application, the transmitter is further configured to transmit an indication in a PUCCH resource for state reporting associated with the SL transmission, wherein the indication indicates a result of the first LBT operation regarding whether the first LBT operation is successful or not and/or a feedback for the SL transmission.

In some embodiments of the present application, the receiver is configured to: receive, from a second UE, second information associated with a second LBT operation performed by the second UE, wherein the second information associated with the second LBT operation indicates at least one of: an LBT type of the second LBT operation; or a remaining COT associated with the second LBT operation; and the processor is configured to determine the LBT type of the first LBT operation based at least in part on the second information.

In some embodiments of the present application, in the case that an LBT type indicated by a first indication included in DCI scheduling the SL transmission is LBT category 4 and a second indication included in the DCI indicates that the first UE to determine the LBT type of the first LBT operation based on the first UE's own determination, the processor is configured to: determine the LBT type of the first LBT operation to be LBT category 2 in response to the LBT type of the second LBT operation being LBT category 4 and/or the remaining COT associated with the second LBT operation being larger than 0; and determine the LBT type of the first LBT operation to be LBT category 4 in response to no received information indicating that an LBT type of an LBT operation performed by another UE is LBT category 4 and/or no received information indicating that a remaining COT associated with an LBT operation performed by another UE is larger than 0.

In some embodiments of the present application, the processor is configured to: determine the LBT type of the first LBT operation to be LBT category 2 in response to the LBT type of the second LBT operation being LBT category 4 and/or the remaining COT associated with the second LBT operation being larger than 0; and determine the LBT type of the first LBT operation to be LBT category 4 in response to no received information indicating that an LBT type of an LBT operation performed by another UE is LBT category 4 and/or no received information indicating that a remaining COT associated with an LBT operation performed by another UE is larger than 0.

According to some other embodiments of the present application, a BS may include: a transmitter configured to: transmit, to a UE, first DCI scheduling a first SL transmission on an unlicensed spectrum, wherein the first DCI includes a first indication indicating an LBT type of a first LBT operation for the first SL transmission; a processor coupled to the transmitter; and a receiver coupled to the processor.

In some embodiments of the present application, the first DCI further includes a second indication indicating the UE to determine an LBT type of the first LBT operation based on the first indication or based on the UE's own determination.

In some embodiments of the present application, the first DCI further includes a third indication indicating the UE to report a result of the first LBT operation regarding whether the first LBT operation is successful or not.

In some embodiments of the present application, the first DCI further includes a fourth indication indicating a PUCCH resource for the UE to report a result of the first LBT operation regarding whether the first LBT operation is successful or not.

In some embodiments of the present application, the fourth indication indicates a time gap between a time slot in which the first DCI is received by the UE and a time slot for reporting the result of the first LBT operation or a time gap between a time slot in which the first SL transmission is performed and a time slot for reporting the result of the first LBT operation.

In some embodiments of the present application, the fourth indication indicates one configuration of one or more configurations included in configuration information configured or pre-configured to the UE, and each configuration indicates an offset from a time slot in which the first DCI is received by the UE to a time slot for reporting the result of the first LBT operation or an offset from a time slot in which the first SL transmission is performed to a time slot for reporting the result of the first LBT operation.

In some embodiments of the present application, the receiver is configured to receive a fifth indication in a PUCCH resource for state reporting associated with the first SL transmission, wherein the fifth indication indicates a result of the first LBT operation regarding whether the first LBT operation is successful or not and/or a feedback for the first SL transmission.

In some embodiments of the present application, the transmitter is further configured to transmit second DCI scheduling a second SL transmission on an unlicensed spectrum, the second DCI indicating an LBT type of a second LBT operation for the second SL transmission; wherein in the case that a result received from the UE indicates that the first LBT operation is successful and a remaining COT associated with the first LBT operation calculated by the BS is larger than 0, the LBT type of the second LBT operation indicated by the second DCI is LBT category 2; and wherein in the case that the BS does not receive a result from the UE which indicates whether the first LBT operation is successful, or a result received from the UE indicates that the first LBT operation is not successful, or the remaining COT associated with the first LBT operation calculated by the BS is 0, the LBT type of the second LBT operation indicated by the second DCI is LBT category 4.

According to some embodiments of the present application, a method performed by a first UE may include: determining an LBT type of a first LBT operation for an SL transmission on an unlicensed spectrum; performing the first LBT operation; and transmitting first information associated with the first LBT operation in SCI when the first LBT operation is successful.

In some embodiments of the present application, the first information associated with the first LBT operation indicates at least one of: the LBT type of the first LBT operation; or a remaining COT associated with the first LBT operation.

In some embodiments of the present application, the method may further include: receiving DCI scheduling the SL transmission; and the LBT type of the first LBT operation is determined based at least in part on the DCI.

In some embodiments of the present application, the DCI includes a first indication indicating an LBT type for the first UE.

In some embodiments of the present application, the DCI further includes a second indication indicating the first UE to determine the LBT type of the first LBT operation based on the first indication or based on the first UE's own determination.

In some embodiments of the present application, the DCI includes an indication indicating the first UE to report a result of the first LBT operation regarding whether the first LBT operation is successful or not.

In some embodiments of the present application, the DCI includes an indication indicating a PUCCH resource for the first UE to report a result of the first LBT operation regarding whether the first LBT operation is successful or not, and the method may further include transmitting the result of the first LBT operation based on the indication.

In some embodiments of the present application, the indication indicates a time gap between a time slot in which the DCI is received and a time slot for reporting the result of the first LBT operation or a time gap between a time slot in which the SL transmission is performed and a time slot for reporting the result of the first LBT operation.

In some embodiments of the present application, the method may further include: obtaining configuration information configured or pre-configured to the first UE, the configuration information includes one or more configurations, and each configuration indicates an offset from a time slot in which the DCI is received to a time slot for reporting the result of the first LBT operation or an offset from a time slot in which the SL transmission is performed to a time slot for reporting the result of the first LBT operation; wherein the indication indicates one configuration of the one or more configurations.

In some embodiments of the present application, the method may further include: transmitting an indication in a PUCCH resource for state reporting associated with the SL transmission, wherein the indication indicates a result of the first LBT operation regarding whether the first LBT operation is successful or not and/or a feedback for the SL transmission.

In some embodiments of the present application, the method may further include: receiving, from a second UE, second information associated with a second LBT operation performed by the second UE, wherein the second information associated with the second LBT operation indicates at least one of: an LBT type of the second LBT operation; or a remaining COT associated with the second LBT operation; and the LBT type of the first LBT operation is determined based at least in part on the second information.

In some embodiments of the present application, in the case that an LBT type indicated by a first indication included in DCI scheduling the SL transmission is LBT category 4 and a second indication included in the DCI indicates that the first UE to determine the LBT type of the first LBT operation based on the first UE's own determination, the LBT type of the first LBT operation is determined to be LBT category 2 in response to the LBT type of the second LBT operation being LBT category 4 and/or the remaining COT associated with the second LBT operation being larger than 0; and the LBT type of the first LBT operation is determined to be LBT category 4 in response to no received information indicating that an LBT type of an LBT operation performed by another UE is LBT category 4 and/or no received information indicating that a remaining COT associated with an LBT operation performed by another UE is larger than 0.

In some embodiments of the present application, the LBT type of the first LBT operation is determined to be LBT category 2 in response to the LBT type of the second LBT operation being LBT category 4 and/or the remaining COT associated with the second LBT operation being larger than 0; and the LBT type of the first LBT operation is determined to be LBT category 4 in response to no received information indicating that an LBT type of an LBT operation performed by another UE is LBT category 4 and/or no received information indicating that a remaining COT associated with an LBT operation performed by another UE is larger than 0.

According to some other embodiments of the present application, a method performed by a BS may include: transmitting, to a UE, first DCI scheduling a first SL transmission on an unlicensed spectrum, wherein the first DCI includes a first indication indicating an LBT type of a first LBT operation for the first SL transmission.

In some embodiments of the present application, the first DCI further includes a second indication indicating the UE to determine an LBT type of the first LBT operation based on the first indication or based on the UE's own determination.

In some embodiments of the present application, the first DCI further includes a third indication indicating the UE to report a result of the first LBT operation regarding whether the first LBT operation is successful or not.

In some embodiments of the present application, the first DCI further includes a fourth indication indicating a PUCCH resource for the UE to report a result of the first LBT operation regarding whether the first LBT operation is successful or not.

In some embodiments of the present application, the fourth indication indicates a time gap between a time slot in which the first DCI is received by the UE and a time slot for reporting the result of the first LBT operation or a time gap between a time slot in which the first SL transmission is performed and a time slot for reporting the result of the first LBT operation.

In some embodiments of the present application, the fourth indication indicates one configuration of one or more configurations included in configuration information configured or pre-configured to the UE, and each configuration indicates an offset from a time slot in which the first DCI is received by the UE to a time slot for reporting the result of the first LBT operation or an offset from a time slot in which the first SL transmission is performed to a time slot for reporting the result of the first LBT operation.

In some embodiments of the present application, the method may further include: receiving a fifth indication in a PUCCH resource for state reporting associated with the first SL transmission, wherein the fifth indication indicates a result of the first LBT operation regarding whether the first LBT operation is successful or not and/or a feedback for the first SL transmission.

In some embodiments of the present application, the method may further include: transmitting second DCI scheduling a second SL transmission on an unlicensed spectrum, the second DCI indicating an LBT type of a second LBT operation for the second SL transmission; wherein in the case that a result received from the UE indicates that the first LBT operation is successful and a remaining COT associated with the first LBT operation calculated by the BS is larger than 0, the LBT type of the second LBT operation indicated by the second DCI is LBT category 2; and wherein in the case that the BS does not receive a result from the UE which indicates whether the first LBT operation is successful, or a result received from the UE indicates that the first LBT operation is not successful, or the remaining COT associated with the first LBT operation calculated by the BS is 0, the LBT type of the second LBT operation indicated by the second DCI is LBT category 4.

Embodiments of the present application provide technical solutions for SL transmission, which include but are not limited to apparatuses and methods for SL transmission on unlicensed spectrum for mode 1 and mode 2.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates a flowchart of an exemplary method for SL transmission on unlicensed spectrum according to some embodiments of the present application;

FIG. 3 illustrates exemplary PUCCH resources for reporting a result of an LBT operation according to some embodiments of the present application;

FIG. 4 illustrates a flowchart of another exemplary method for SL transmission on unlicensed spectrum according to some other embodiments of the present application; and

FIG. 5 illustrates a simplified block diagram of an exemplary apparatus for SL transmission on unlicensed spectrum according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

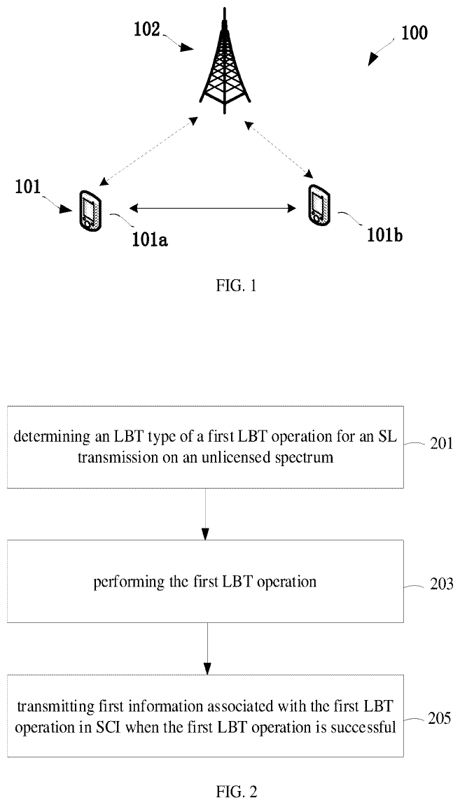

FIG. 1 illustrates an exemplary wireless communication system 100 in accordance with some embodiments of the present application.

As shown in FIG. 1, the wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, a UE is a pedestrian UE (P-UE or PUE) or a cyclist UE. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BS(s) 102 via LTE or NR Uu interface. Moreover, UE(s) 101 may work in a wider Internet-of-Thing (IoT) or Industrial IoT (IIoT) scenario with increased demand(s) of low air-interface latency and/or high reliability to be addressed, which includes such as factory automation, electrical power distribution, and/or transport industry.

In some embodiments of the present application, each of UE(s) 101 may be deployed an IoT application, an enhanced mobile broadband (eMBB) application and/or an ultra-reliable and low latency communications (URLLC) application. For instance, UE 101a may implement an IoT application and may be named as an IoT UE, while UE 101b may implement an eMBB application and/or a URLLC application and may be named as an eMBB UE, a URLLC UE, or an eMBB/URLLC UE. It is contemplated that the specific type of application(s) deployed in UE(s) 101 may be varied and not limited.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 may transmit data using an orthogonal frequency division multiplexing (OFDM) modulation scheme on the downlink (DL) and UE(s) 101 may transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 and/or UE(s) 101 may communicate using other communication protocols, such as the IEEE 802.11 family of wireless communication protocols. Further, in some embodiments of the present application, BS(s) 102 and/or UE(s) 101 may communicate over licensed spectrums, whereas in other embodiments of the present application, BS(s) 102 and/or UE(s) 101 may communicate over unlicensed spectrums. The present application is not intended to be limited to the implementation of any particular wireless communication system architecture or protocol. In yet some embodiments of the present application, BS(s) 102 may communicate with UE(s) 101 using the 3GPP 5G protocols.

For sidelink transmission, resource allocation may be implemented by two modes, i.e., resource allocation mode 1 and resource allocation mode 2.

In the case of resource allocation mode 1, a sidelink transmission (e.g., a PSSCH transmission and/or a PSCCH transmission) can be carried out by a UE only if the UE has been provided by a BS with a valid scheduling grant that indicates the exact set of resources used for the sidelink transmission.

In the case of resource allocation mode 2, a decision on sidelink transmission, including decision on the exact set of resources to be used for the sidelink transmission, is made by the transmitting UE (also referred to as Tx UE) based on a sensing-based resource (re-)selection procedure. Resource allocation mode 2 is applicable to both in-coverage and out-of-coverage deployment scenarios.

In RP-213678, a new work item (WID) on sidelink is approved. The new WID at least includes the following objective: studying and specifying support of sidelink on unlicensed spectrum for both mode 1 (i.e., resource allocation mode 1) and mode 2 (i.e., resource allocation mode 1), where Uu operation for mode 1 is limited to licensed spectrum only.

Regardless of mode 1 or mode 2, for an SL transmission on the unlicensed spectrum, before performing the SL transmission, a UE may perform an LBT procedure (or an LBT operation) to determine whether it can use the unlicensed spectrum. There are multiple categories (or types) of LBT procedures, for example, LBT category 1 (also referred to as LBT Cat1), LBT category 2 (also referred to as LBT Cat2), LBT category 3 (also referred to as LBT Cat3), and LBT category 4 (also referred to as LBT Cat4).

Specifically, LBT Cat1 means that no LBT procedure is performed by a transmitter.

LBT Cat2 means that an LBT procedure is performed without random back-off, and a time duration that a channel is sensed to be idle before the transmitter transmits the SL transmission on the channel is deterministic. LBT Cat2 may also be referred to as one-shot LBT.

LBT Cat3 means that an LBT procedure is performed with random back-off with a fixed contention window size. In LBT Cat3, a transmitter draws a random number N within a contention window, wherein a size of the contention window is fixed and is specified by a minimum value and a maximum value of N. The random number N is used in the LBT procedure to determine a time duration that the channel is sensed to be idle before the transmitter transmits the SL transmission on the channel.

LBT Cat4 means that an LBT procedure is performed with random back-off with a variable contention window size. Similarly, a transmitter draws a random number M within a contention window, wherein a size of the contention window is specified by a minimum value and a maximum value of M. The transmitter can vary the size of the contention window when drawing the random number M. The random number M is used in the LBT procedure to determine a time duration that the channel is sensed to be idle before the transmitter transmits the SL transmission on the channel.

Given the above, how a Tx UE in mode 1 or mode 2 determines an LBT type of an LBT procedure for an SL transmission before performing the SL transmission needs to be addressed.

For example, for a Tx UE in mode 1, the network (e.g., a BS) may schedule an SL transmission on unlicensed spectrum, and before performing the SL transmission, the Tx UE may perform an LBT procedure. In such embodiments, the network may transmit information to help the Tx UE to determine the LBT type of the LBT procedure. The detailed solution for the information needs to be designed.

In another example, for a Tx UE in mode 2, it may determine the resources for an SL transmission. Before performing the SL transmission, the Tx UE may also perform an LBT procedure. In such embodiments, how the Tx UE determines the LBT type of the LBT procedure needs to be addressed.

In some cases, the Tx UE may provide assistant information to the network, which may help the network to determine the LBT type of an LBT procedure for a subsequent SL transmission to be performed by the Tx UE or another UE. In such cases, the kind of assistant information and how to transmit the assistant information need to be designed.

In some cases, the Tx UE may transmit information indicating its LBT type to other UE(s), which may help the other UE(s) to determine their LBT type(s). In such cases, the detailed solution for the information needs to be designed. In addition, the Tx UE may also receive information indicating LBT type(s) from other UE(s). In such cases, the Tx UE's behaviour also needs to be defined.

Given the above, embodiments of the present application provide improved solutions for SL transmission on unlicensed spectrum, which can solve at least one of the above technical problems, thereby supporting SL transmission on unlicensed spectrum for both mode 1 and mode 2. More details on embodiments of the present application will be illustrated in the following text in combination with the appended drawings.

FIG. 2 illustrates a flowchart of an exemplary method for SL transmission on unlicensed spectrum according to some embodiments of the present application. The method illustrated in FIG. 2 may be performed by a first UE (e.g., UE 101a or UE 101b in FIG. 1) or other apparatus with the like functions. In the embodiments of FIG. 2, the first UE may be a Tx UE.

As shown in FIG. 2, in step 201, the first UE may determine an LBT type of a first LBT operation for an SL transmission on an unlicensed spectrum.

According to some embodiments of the present application, the first UE may be in mode 1. In such embodiments, the UE may receive DCI on a licensed spectrum from a BS (e.g., BS 102 in FIG. 1), and the DCI may schedule the SL transmission on the unlicensed spectrum. The SL transmission may include at least one of physical sidelink control channel (PSCCH) transmission (e.g., SCI) or physical sidelink shared channel (PSSCH) transmission. In such embodiments, the first UE may determine the LBT type of the first LBT operation based at least in part on the DCI.

In some embodiments, the DCI scheduling the SL transmission may include a first indication indicating an LBT type for the first UE. The LBT type may be LBT Cat1, LBT Cat2, LBT Cat3, or LBT Cat4. In an embodiment, after receiving the first indication, the first UE may determine the LBT type of the first LBT operation to be the LBT type indicated by the first indication.

In an embodiment of the present application, the LBT type indicated by the first indication may be one of LBT Cat2 or LBT Cat4. For example, the first indication may be a 1-bit indication, wherein the value of the bit being “1” may indicate that the LBT type is LBT Cat4 and the value of the bit being “0” may indicate that the LBT type is LBT Cat2, or the value of the bit being “0” may indicate that the LBT type is LBT Cat4 and the value of the bit being “1” may indicate that the LBT type is LBT Cat2.

In some embodiments, in addition to the first indication, the DCI scheduling the SL transmission may further include a second indication indicating the first UE to determine the LBT type of the first LBT operation based on a network's indication (e.g., the first indication) or based on the first UE's own determination. For example, the second indication may be a 1-bit indication, wherein the value of the bit being “1” indicates the first UE to determine the LBT type of the first LBT operation based on the network's indication and the value of the bit being “O” indicates the first UE to determine the LBT type of the first LBT operation based on the first UE's own determination, or the value of the bit being “0” indicates the first UE to determine the LBT type of the first LBT operation based on the network's indication and the value of the bit being “1” indicates the first UE to determine the LBT type of the first LBT operation based on the first UE's own determination.

In the case that the second indication indicates the first UE to determine the LBT type of the first LBT operation based on the network's indication, the first UE may determine the LBT type of the first LBT operation to be the LBT type indicated by the first indication as described above.

In the case that the second indication indicates the first UE to determine the LBT type of the first LBT operation based on the first UE's own determination, the first UE may determine the LBT type of the first LBT operation according to its own configurations or pre-configurations, assistant information obtained from other UE(s) or the BS, etc. Illustrative examples will be described below.

In an embodiment, the first UE may always determine the LBT type of the first LBT operation to be LBT Cat4 when the second indication indicates the first UE to determine the LBT type of the first LBT operation based on the first UE's own determination, regardless of the first indication.

In another embodiment, in the case that the first UE successfully performed a previous LBT operation for a previous SL transmission, wherein the LBT type of the previous LBT operation is LBT Cat4 and the remaining COT associated with the previous LBT operation is larger than 0, the first UE may determine the LBT type of the first LBT operation to be one-shot LBT (i.e., LBT Cat2) when the second indication indicates the first UE to determine the LBT type of the first LBT operation based on the first UE's own determination even if the first indication indicates LBT Cat4. In other words, the first UE may perform the SL transmission in the remaining COT associated with the previous LBT operation when the first LBT operation is successful. The remaining COT associated with the previous LBT operation may refer to the remaining time or time slot(s) in the COT initiated by the previous LBT operation after the previous SL transmission is completed, which can be calculated by the first UE. The remaining COT may be in units of milliseconds or in units of time slots (also referred to as slots). In some embodiments, the time slots may be logical slots, which are continuous in the time domain. In some other embodiments, the time slots may be physical slots, which are continuous in the resource pool for the first UE but may be discontinuous in the time domain.

In yet another embodiment, before determining the LBT type of the first LBT operation, the first UE may receive information associated with a second LBT operation performed by a second UE. The information associated with the second LBT operation may indicate at least one of: an LBT type of the second LBT operation; or a remaining COT associated with the second LBT operation. The remaining COT may be in units of milliseconds or in units of time slots (also referred to as slots). In some embodiments, the time slots may be logical slots, which are continuous in the time domain. In some other embodiments, the time slots may be physical slots, which are continuous in the resource pool but may be discontinuous in the time domain.

The first UE may determine the LBT type of the first LBT operation based at least in part on the received information associated with the second LBT operation when the second indication indicates the first UE to determine the LBT type of the first LBT operation based on the first UE's own determination. For example, the first indication may indicate LBT Cat4 for the first UE and the second indication may indicate the first UE to determine the LBT type of the first LBT operation based on the first UE's own determination. In such example, in the case that the first UE receives information associated with a second LBT operation performed by a second UE which indicates that the LBT type of the second LBT operation is LBT Cat4 and/or the remaining COT associated with the second LBT operation is larger than 0, the first UE may determine that the LBT type of the first LBT operation to be LBT Cat2 (i.e., one-shot LBT). In other words, the first UE may perform the SL transmission in the remaining COT associated with the second LBT operation when the first LBT operation is successful. In the case that the first UE does not receive any information indicating that an LBT type of a second LBT operation performed by a second UE is LBT Cat4 (e.g., the first UE does not receive any information associated with LBT operation(s) performed by other UE(s) or the first UE only receives information associated with LBT operation(s) perform by other UE(s) which indicates that an LBT type of the associated LBT operation(s) is LBT Cat2) and/or the first UE only receives information associated with LBT operation(s) performed by other UE(s) which indicates that the remaining COT associated with the associated LBT operation(s) is 0 (i.e., no received information indicates that the remaining COT associated with the associated LBT operation is larger than 0), the first UE may determine the LBT type of the first LBT operation to be LBT Cat4.

According to some other embodiments of the present application, the first UE may be in mode 2. In such embodiments, the first UE may determine the LBT type of the first LBT operation by itself, e.g., according to its own configurations or pre-configurations, assistant information obtained from other UE(s) or the BS, etc. Illustrative examples will be described below.

In an embodiment, the first UE may always determine the LBT type of the first LBT operation to be LBT Cat4.

In another embodiment, in the case that the first UE successfully performed a previous LBT operation for a previous SL transmission, wherein the LBT type of the previous LBT operation is LBT Cat4 and the remaining COT associated with the previous LBT operation is larger than 0, the first UE may determine the LBT type of the first LBT operation to be one-shot LBT (i.e., LBT Cat2). In other words, the first UE may perform the SL transmission in the remaining COT associated with the previous LBT operation when the first LBT operation is successful.

In yet another embodiment, before determining the LBT type of the first LBT operation, the first UE may receive information associated with a second LBT operation performed by a second UE. The information associated with the second LBT operation may indicate at least one of: an LBT type of the second LBT operation; or a remaining COT associated with the second LBT operation. The first UE may determine the LBT type of the first LBT operation based at least in part on the received information associated with the second LBT operation. For example, in the case that the information associated with the second LBT operation indicates that the LBT type of the second LBT operation is LBT Cat4 and/or the remaining COT associated with the second LBT operation is larger than 0, the first UE may determine that the LBT type of the first LBT operation to be LBT Cat2 (i.e., one-shot LBT). In other words, the first UE may perform the SL transmission in the remaining COT associated with the second LBT operation when the first LBT operation is successful. In the case that the first UE does not receive any information indicating that an LBT type of an LBT operation performed by another UE is LBT Cat4 (e.g., the first UE does not receive any information associated with LBT operation(s) performed by other UE(s) or the first UE only receives information associated with LBT operation(s) perform by other UE(s) which indicates that an LBT type of the associated LBT operation(s) is LBT Cat2) and/or the first UE only receives information associated with LBT operation(s) performed by other UE(s) which indicates that the remaining COT associated with the associated LBT operation(s) is 0 (i.e., no received information indicates that the remaining COT associated with the associated LBT operation is larger than 0), the first UE may determine the LBT type of the first LBT operation to be LBT Cat4.

Referring back to FIG. 2, after determining the LBT type of the first LBT operation, in step 203, the first UE may perform the first LBT operation. The first LBT operation may be successful or not.

When the first UE is in mode 1, in some cases (e.g., the first indication in the DCI scheduling the SL transmission indicates LBT Cat4 for the first UE), the first UE may report the result of the first LBT operation (i.e., whether the first LBT operation is successful or not) to the network (e.g., the BS) such that the network may use the result of the first LBT operation to determine an LBT type of a subsequent LBT operation to be performed by the first UE or another UE.

In some embodiments of the present application, the DCI scheduling the SL transmission may include a third indication to indicate the first UE to report the result of the first LBT operation regarding whether the first LBT operation is successful or not. For example, the third indication may be a 1-bit indication, wherein the value of the bit being “1” indicates that the first UE to report the result of the first LBT operation to the network and the value of the bit being “0” indicates that the first UE not to report the result of the first LBT operation to the network.

Alternatively or additionally, in some embodiments of the present application, the DCI scheduling the SL transmission may include a fourth indication indicating a PUCCH resource for the first UE to report the result of the first LBT operation regarding whether the first LBT operation is successful or not. Then, after receiving the fourth indication, the first UE may transmit the result of the first LBT operation based on the fourth indication. In the case that the DCI does not include the third indication, the fourth indication may be used to implicitly indicate whether or not the first UE should report the result of the first LBT operation to the network. For example, the fourth indication with a predefined value may indicate the first UE not to report the result of the first LBT operation to the network.

In an embodiment of the present application, the fourth indication may indicate a time gap between a time slot in which the DCI scheduling the SL transmission is received and a time slot for reporting the result of the first LBT operation. In such embodiment, the fourth indication may be referred to as sl-DCI-toUL-reporting. In an embodiment of the present application, the time gap may be in units of time slots and thus includes zero or more time slots. In some embodiments, the time slot(s) included in the time gap may be logical slot(s), which are continuous in the time domain. In some other embodiments, the time slot(s) included in the time gap may be physical slot(s), which are continuous in the resource pool but may be discontinuous in the time domain.

In some embodiments, in the case that the time gap indicated by the fourth indication is 0, it may indicate the first UE not to report the result of the first LBT operation to the network; in the case that the time gap indicated by the fourth indication is larger than 0, the first UE may report the result of the first LBT operation based on the time gap.

For example, it is assumed that the first UE receives the DCI in slot #n, and the fourth indication indicates that the time gap is k time slots (wherein k is larger than 0). Then, the first UE may transmit the result of the first LBT operation in a PUCCH resource in time slot #n+k. For example, the PUCCH resource may be at the end (for example, in one or more last symbols) of time slot #n+k. In such embodiments, the location of the PUCCH resource in the frequency domain may be determined based on the configuration as specified in 3GPP standard documents (e.g., same as legacy PUCCH resource configuration).

For example, the fourth indication may be a 2-bit indication, wherein the value “00” indicates that the time gap is 0 time slot (i.e., the first UE does not need to report the result of the first LBT operation to the network), the value “01” indicates that the time gap is 1 time slot (i.e., the PUCCH resource for reporting the result of the first LBT operation is in slot #n+1), the value “10” indicates that the time gap is 2 time slots (i.e., the PUCCH resource for reporting the result of the first LBT operation is in slot #n+2), and the value “11” indicates the time gap is 3 time slots (i.e., the PUCCH resource for reporting the result of the first LBT operation is in slot #n+3).

In another embodiment of the present application, the fourth indication may indicate a time gap between a time slot in which the SL transmission is performed and a time slot for reporting the result of the first LBT operation. In an embodiment of the present application, the time gap may be in units of time slots and thus includes zero or more time slots. In some embodiments, the time slot(s) included in the time gap may be logical slot(s), which are continuous in the time domain. In some other embodiments, the time slot(s) included in the time gap may be physical slot(s), which are continuous in the resource pool but may be discontinuous in the time domain.

For example, it is assumed that the SL transmission is performed in slot #n, and the fourth indication indicates that the time gap is k time slots (k is equal to or larger than 0). Then, the first UE may transmit the result of the first LBT operation in a PUCCH resource in time slot #n+k. For example, the PUCCH resource may be at the end (for example, in one or more last symbols) of time slot #n+k. In such embodiments, the location of the PUCCH resource in the frequency domain may be determined based on the configuration as specified in 3GPP standard documents (e.g., same as legacy PUCCH resource configuration).

For example, the fourth indication may be a 2-bit indication, wherein the value “00” indicates that the time gap is 0 time slot (i.e., the PUCCH resource for reporting the result of the first LBT operation is in slot #n), the value “01” indicates that the time gap is 1 time slot (i.e., the PUCCH resource for reporting the result of the first LBT operation is in slot #n+1), the value “10” indicates that the time gap is 2 time slots (i.e., the PUCCH resource for reporting the result of the first LBT operation is in slot #n+2), and the value “11” indicates the time gap is 3 time slots (i.e., the PUCCH resource for reporting the result of the first LBT operation is in slot #n+3). In another example, the value “11” may indicate the first UE not to report the result of the first LBT operation to the network.

In yet another embodiment of the present application, before receiving the DCI, the first UE may obtain configuration information configured or pre-configured to the first UE. The configuration information includes one or more configurations, and each configuration indicates an offset from a time slot in which the DCI is received to a time slot for reporting the result of the first LBT operation. In an embodiment of the present application, the offset may be in units of time slots and thus includes zero or more time slots. In some embodiments, the time slot(s) included in the offset may be logical slot(s), which are continuous in the time domain. In some other embodiments, the time slot(s) included in the offset may be physical slot(s), which are continuous in the resource pool but may be discontinuous in the time domain.

In an embodiment, obtaining configuration information configured to the first UE may refer to that: the configuration information is transmitted by a BS (e.g., BS 102 as shown in FIG. 1) to the first UE via a signaling, e.g., a system information block (SIB), a master information block (MIB), a radio resource control (RRC) signaling, a medium access control (MAC) layer control element (CE), or DCI, such that the first UE may receive the configuration information from the BS.

In another embodiment, obtaining the configuration information pre-configured to the first UE may refer to that: the configuration information may be hard-wired into the first UE or stored on a subscriber identity module (SIM) or universal subscriber identity module (USIM) card for the first UE, such that the first UE may obtain the configuration information within the first UE.

The following Table 1 shows an example of the configuration information.

TABLE 1

| | offset (unit: time slot) |
|---|---|
| 00 | 0 |
| 01 | 1 |
| 10 | 2 |
| 11 | 3 |

Referring to Table 1, the configuration information includes four configurations respectively represented by “00,” “01,” “10,” and “11,” wherein the configuration “00” indicates that the offset is 0 time slot, the configuration “01” indicates that the offset is 1 time slot, the configuration “10” indicates that the offset is 2 time slots, and the configuration “11” indicates that the offset is 3 time slots.

In the above embodiments, the fourth indication included in the DCI may indicate one configuration of the one or more configurations. The number of bits included in the fourth indication may be determined based on the number of configurations included in the configuration information. For example, the number of bits included in the fourth indication may be equal to ┌log₂ N┐, wherein N is the number of configurations included in the configuration information. For example, for the configuration information as shown in Table 1, the fourth indication may include 2 bits, e.g., the fourth indication being “00,” “01,” “10,” and “11” may indicate the configuration “00,” “01,” “10,” and “11,” respectively.

In some embodiments, in the case that the offset indicated by the configuration indicated by the fourth indication is 0, it may indicate the first UE not to report the result of the first LBT operation to the network; in the case that the offset indicated by the configuration indicated by the fourth indication is larger than 0, the first UE may report the result of the first LBT operation based on the offset.

For example, it is assumed that the first UE receives the DCI in slot #n, and the configuration indicated by the fourth indication indicates that the offset is k slots (wherein k is larger than 0). Then, the first UE may transmit the result of the first LBT operation in a PUCCH resource in slot #n+k. For example, the PUCCH resource may be at the end (for example, in one or more last symbols) of time slot #n+k. In such embodiments, the location of the PUCCH resource in the frequency domain may be determined based on the configuration as specified in 3GPP standard documents (e.g., same as legacy PUCCH resource configuration).

In yet another embodiment of the present application, before receiving the DCI, the first UE may obtain configuration information configured or pre-configured to the first UE. The configuration information includes one or more configurations, and each configuration indicates an offset from a time slot in which the SL transmission is performed to a time slot for reporting the result of the first LBT operation. For example, the configuration information may be the same as that shown in Table 1. In an embodiment of the present application, the offset may be in units of time slots and thus includes zero or more time slots. In some embodiments, the time slot(s) included in the offset may be logical slot(s), which are continuous in the time domain. In some other embodiments, the time slot(s) included in the offset may be physical slot(s), which are continuous in the resource pool but may be discontinuous in the time domain.

The fourth indication included in the DCI may indicate one configuration of the one or more configurations. The number of bits included in the fourth indication may be determined based on the number of configurations included in the configuration information. For example, the number of bits included in the fourth indication may be equal to ┌log₂ N┐, wherein N is the number of configurations included in the configuration information. For example, for the configuration information as shown in Table 1, the fourth indication may include 2 bits.

For example, it is assumed that the SL transmission is performed in slot #n, and the configuration indicated by the fourth indication indicates that the offset is k slots (k is equal to or larger than 0). Then, the first UE may transmit the result of the first LBT operation in a PUCCH resource in slot #n+k. For example, the PUCCH resource may be at the end (for example, in one or more last symbols) of time slot #n+k. In such embodiments, the location of the PUCCH resource in the frequency domain may be determined based on the configuration as specified in 3GPP standard documents (e.g., same as legacy PUCCH resource configuration).

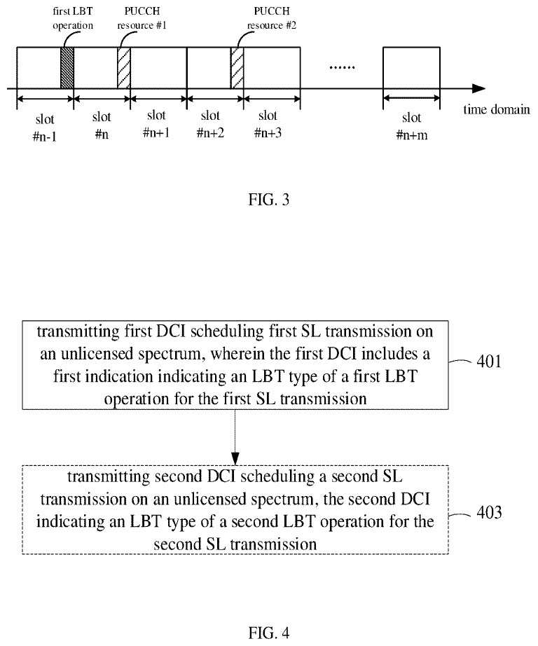

FIG. 3 illustrates exemplary PUCCH resources for reporting a result of an LBT operation according to some embodiments of the present application.

Referring to FIG. 3, it is assumed that: the first UE receives DCI scheduling an SL transmission in slot #n-1 (e.g., in the first one or more symbols of slot #n-1) or before slot #n-1 (not shown in FIG. 3); then, the first UE performs the first LBT operation at the last one or more symbols in slot #n-1; after that, the first UE performs the SL transmission in slot #n.

Moreover, it is assumed that the configuration information includes two configurations, e.g., configuration #1 and configuration #2. Configuration #1 indicates an offset from a time slot in which the SL transmission is performed to a time slot for reporting the result of the first LBT operation is 0 time slot. Configuration #2 indicates an offset from a time slot in which the SL transmission is performed to a time slot for reporting the result of the first LBT operation is 2 time slots.

In the case that the fourth indication in the DCI indicates configuration #1, the first UE may transmit the result of the first LBT operation in PUCCH resource #1, e.g., at the last one or more symbols in slot #n, wherein the number of symbols for PUCCH resource #1 is pre-configured or configured to the first UE and the location of the PUCCH resource #1 in the frequency domain is determined based on the configuration as specified in 3GPP standard documents.

In the case that the fourth indication in the DCI indicates configuration #2, the first UE may transmit the result of the first LBT operation in PUCCH resource #2, e.g., at the last one or more symbols in slot #n+2, wherein the number of symbols for PUCCH resource #2 is pre-configured or configured to the first UE and the location of the PUCCH resource #2 in the frequency domain is determined based on the configuration as specified in 3GPP standard documents.

In some other embodiments of the present application, the DCI scheduling the SL transmission may not include the fourth indication. In other words, the BS may not indicate or configure a separated resource for reporting the result of the first LBT operation. Instead, the first UE may reuse a PUCCH resource for state (e.g., acknowledgement (ACK), non-acknowledgement (NACK), or discontinuous transmission (DTX)) reporting associated with the SL transmission to report the result of the first LBT operation.

For example, the PUCCH resource for state reporting associated with the SL transmission may be indicated by a PSFCH-to-HARQ feedback timing indicator in the DCI as specified in 3GPP standard documents. The PSFCH-to-HARQ feedback timing indicator may include ┌log₂ N_{fb_timing}┐ bits, wherein N_{fb_timing} is the number of entries in the higher layer parameter sl-PSFCH-ToPUCCH as specified in TS 38.213.

In such embodiments, the first UE may transmit an indication in the PUCCH resource for state reporting associated with the SL transmission. The indication indicates a result of the first LBT operation regarding whether the first LBT operation is successful not and/or a feedback for the SL transmission.

The following Table 2 shows examples of the indication transmitted by the first UE in the PUCCH resource for state reporting associated with the SL transmission.

TABLE 2

| | |
|---|---|
| 00 | The first LBT operation is successful, and the |
| | feedback for the SL transmission is ACK. |
| 01 | The first LBT operation is successful, and the |
| | feedback for the SL transmission is NACK/DTX, |
| 10 | The first LBT operation is failed |
| 11 | N/A |

Referring to Table 2, the indication may include 2 bits, wherein the value “00” may indicate that the first LBT operation (e.g., whose LBT type is LBT Cat4) is successful and the feedback for the SL transmission is ACK, the value “01” may indicate that the first LBT operation (e.g., whose LBT type is LBT Cat4) is successful and the feedback for the SL transmission is NACK or DTX, and the value “10” may indicate that the first LBT operation (e.g., whose LBT type is LBT Cat4) is failed.

When the first LBT operation is successful, the first UE may perform the SL transmission including SCI on PSCCH and data on PSSCH. For example, in step 205, the first UE may transmit the SCI scheduling the data on PSSCH to one or more other UEs via a unicast manner, a groupcast manner, or a broadcast manner. The SCI may include first information associated with the first LBT operation such that one or more other UEs may use the first information to determine their LBT types. The first information may be included in at least one of the first stage SCI or the second stage SCI of the SCI.

The first information associated with the first LBT operation may indicate at least one of: the LBT type of the first LBT operation; or a remaining COT associated with the first LBT operation.

In some embodiments, the first information may include an indication indicating the LBT type of the first LBT operation. For example, the indication may be a 1-bit indication, wherein the value “0” indicates that the LBT type of the first LBT operation is LBT Cat2 and the value “1” indicates that the LBT type of the first LBT operation is LBT Cat4, or the value “1” indicates that the LBT type of the first LBT operation is LBT Cat2 and the value “0” indicates that the LBT type of the first LBT operation is LBT Cat4.

Alternatively or additionally, the first information may include another indication indicating the remaining COT associated with the first LBT operation. In an embodiment of the present application, the remaining COT may be in units of milliseconds or in units of time slots. In some embodiments, the time slots may be logical slots, which are continuous in the time domain. In some other embodiments, the time slots may be physical slots, which are continuous in the resource pool but may be discontinuous in the time domain. The another indication may include one or more bits. The number of bits included in the another indication may be determined based on the maximum number of time slots included in the remaining COT. For example, the number of bits included in the another indication may be equal to ┌log₂ L┐, wherein L is the maximum number of time slots included in the remaining COT.

For example, if the remaining COT indicated by the another indication is larger than 0, it may mean that the LBT type of the first LBT operation performed by the first UE is LBT Cat4 and the remaining COT is larger than 0; if the remaining COT indicated by the another indication is 0, it may mean one of: (1) the LBT type of the first LBT operation performed by the first UE is LBT Cat2; or (2) the LBT type of the first LBT operation performed by the first UE is LBT Cat4 and the remaining COT is 0.

The first information as described above may help one or more other UEs to determine their LBT types. For example, after receiving the first information, the one or more other UEs may determine their LBT types based at least in part on the first information by using the same method as the first UE determines the LBT type of the first LBT operation, as described in the above embodiments.

FIG. 4 illustrates a flowchart of another exemplary method for SL transmission on unlicensed spectrum according to some other embodiments of the present application. The method illustrated in FIG. 4 may be performed by a BS (e.g., BS 102 in FIG. 1) or other apparatus with the like functions.

As shown in FIG. 4, in step 401, the BS may transmit first DCI on a licensed spectrum to a first UE (e.g., UE 101a or UE 101b in FIG. 1), and the first DCI may schedule a first SL transmission of the first UE on the unlicensed spectrum. The first SL transmission may include at least one of PSCCH transmission (e.g., SCI) or PSSCH transmission.

In some embodiments, the first DCI may include a first indication indicating an LBT type of a first LBT operation for the first SL transmission. The LBT type may be LBT Cat1, LBT Cat2, LBT Cat3, or LBT Cat4.

In an embodiment of the present application, the LBT type indicated by the first indication may be one of LBT Cat2 or LBT Cat4. For example, the first indication may be a 1-bit indication, wherein the value “1” may indicate that the LBT type is LBT Cat4 and the value “0” may indicate that the LBT type is LBT Cat2, or the value “0” may indicate that the LBT type is LBT Cat4 and the value “1” may indicate that the LBT type is LBT Cat2.

In some embodiments, in addition to the first indication, the first DCI may further include a second indication indicating the first UE to determine the LBT type of the first LBT operation based on a network's indication (e.g., the first indication) or based on the first UE's own determination. For example, the second indication may be a 1-bit indication, wherein the value “1” indicates the first UE to determine the LBT type of the first LBT operation based on the network's indication and the value “O” indicates the first UE to determine the LBT type of the first LBT operation based on the first UE's own determination, or the value “0” indicates the first UE to determine the LBT type of the first LBT operation based on the network's indication and the value “1” indicates the first UE to determine the LBT type of the first LBT operation based on the first UE's own determination.

In some embodiments of the present application, the first DCI scheduling the first SL transmission may include a third indication to indicate the first UE to report a result of the first LBT operation regarding whether the first LBT operation is successful or not (e.g., in the case that the first indication indicates LBT Cat4 for the first UE). For example, the third indication may be a 1-bit indication, wherein the value “1” indicates that the first UE to report the result of the first LBT operation to the network and the value “0” indicates that the first UE not to report the result of the first LBT operation to the network.

Alternatively or additionally, in some embodiments of the present application, the first DCI scheduling the first SL transmission may include a fourth indication indicating a PUCCH resource for the first UE to report the result of the first LBT operation regarding whether the first LBT operation is successful or not. In the case that the DCI does not include the third indication, the fourth indication may be used to implicitly indicate whether or not the first UE should report the result of the first LBT operation to the network. For example, the fourth indication with a predefined value may indicate the first UE not to report the result of the first LBT operation to the network.

In an embodiment of the present application, the fourth indication may indicate a time gap between a time slot in which the first DCI is received and a time slot for reporting the result of the first LBT operation. In such embodiment, the fourth indication may be referred to as sl-DCI-toUL-reporting. In an embodiment of the present application, the time gap may be in units of time slots and thus includes zero or more time slots. In some embodiments, the time slot(s) included in the time gap may be logical slot(s), which are continuous in the time domain. In some other embodiments, the time slot(s) included in the time gap may be physical slot(s), which are continuous in the resource pool but may be discontinuous in the time domain.

In some embodiments, in the case that the time gap indicated by the fourth indication is 0, it may indicate the first UE not to report the result of the first LBT operation to the network; in the case that the time gap indicated by the fourth indication is larger than 0, it may indicate that the first UE to report the result of the first LBT operation based on the time gap.

In another embodiment of the present application, the fourth indication may indicate a time gap between a time slot in which the first SL transmission is performed and a time slot for reporting the result of the first LBT operation. In an embodiment of the present application, the time gap may be in units of time slots and thus includes zero or more time slots. In some embodiments, the time slot(s) included in the time gap may be logical slot(s), which are continuous in the time domain. In some other embodiments, the time slot(s) included in the time gap may be physical slot(s), which are continuous in the resource pool but may be discontinuous in the time domain.

In yet another embodiment of the present application, the fourth indication may indicate one configuration of one or more configurations included in configuration information configured or pre-configured to the first UE, and each configuration indicates an offset from a time slot in which the first DCI is received to a time slot for reporting the result of the first LBT operation. In an embodiment of the present application, the offset may be in units of time slots and thus includes zero or more time slots. In some embodiments, the time slot(s) included in the offset may be logical slot(s), which are continuous in the time domain. In some other embodiments, the time slot(s) included in the offset may be physical slot(s), which are continuous in the resource pool but may be discontinuous in the time domain.

In the above embodiment, the number of bits included in the fourth indication may be determined based on the number of configurations included in the configuration information. For example, the number of bits included in the fourth indication may be equal to ┌log₂ N┐, wherein N is the number of configurations included in the configuration information.

In some embodiments, in the case that the offset indicated by the configuration indicated by the fourth indication is 0 time slot, it may indicate the first UE not to report the result of the first LBT operation to the network; in the case that the offset indicated by the configuration indicated by the fourth indication is larger than 0, it may indicate the first UE to report the result of the first LBT operation based on the offset.

In yet another embodiment of the present application, the fourth indication may indicate one configuration of one or more configurations included in configuration information configured or pre-configured to the UE, and each configuration indicates an offset from a time slot in which the first SL transmission is performed to a time slot for reporting the result of the first LBT operation. In an embodiment of the present application, the offset may be in units of time slots and thus includes zero or more time slots. In some embodiments, the time slot(s) included in the offset may be logical slot(s), which are continuous in the time domain. In some other embodiments, the time slot(s) included in the offset may be physical slot(s), which are continuous in the resource pool but may be discontinuous in the time domain.

In the above embodiment, the number of bits included in the fourth indication may be determined based on the number of configurations included in the configuration information. For example, the number of bits included in the fourth indication may be equal to ┌log₂ N┐, wherein N is the number of configurations included in the configuration information.

In some other embodiments of the present application, the first DCI scheduling the first SL transmission may not include the fourth indication. In other words, the BS may not indicate or configure a separated resource for reporting the result of the first LBT operation. In such embodiments, the BS may receive a fifth indication in a PUCCH resource for state (e.g., ACK, NACK, or DTX) reporting associated with the first SL transmission. The fifth indication may indicate a result of the first LBT operation regarding whether the first LBT operation is successful or not and/or a feedback for the first SL transmission.

For example, the PUCCH resource for state reporting associated with the first SL transmission may be indicated by a PSFCH-to-HARQ feedback timing indicator in the first DCI as specified in 3GPP standard documents. The PSFCH-to-HARQ feedback timing indicator may include ┌log₂ N_{fb_timing}┐ bits, wherein N_{fb_timing} is the number of entries in the higher layer parameter sl-PSFCH-ToPUCCH as specified in TS 38.213.

According to some embodiments of the present application, in step 403, the BS may further transmit second DCI on the licensed spectrum to the first UE or to another UE different from the first UE, and the second DCI may schedule a second SL transmission of the first UE or the another UE on the unlicensed spectrum. The second SL transmission may include at least one of PSCCH transmission (e.g., SCI) or PSSCH transmission. Step 403 may be an optional step, and may not occur in some other embodiments of the present application.

The second DCI may include an indication indicating an LBT type of a second LBT operation for the second SL transmission. In some embodiments, the BS may determine the LBT type of the second LBT operation based on the result of the first LBT operation.

For example, the BS may receive a result indicating that the first LBT operation (e.g., the LBT type of the first LBT operation is LBT Cat4) is successful from the first UE. In such example, after receiving the result, the BS may calculate the remaining COT associated with the first LBT operation. In the case that the remaining COT associated with the first LBT operation calculated by the BS is larger than 0, the LBT type of the second LBT operation indicated by the second DCI may be LBT Cat2. In the case that the remaining COT associated with the first LBT operation calculated by the BS is 0, the LBT type of the second LBT operation indicated by the second DCI is LBT Cat4.

In another example, the BS may receive a result indicating that the first LBT operation (e.g., the LBT type of the first LBT operation is LBT Cat4) is not successful from the first UE, and then the LBT type of the second LBT operation indicated by the second DCI is LBT Cat4.

In yet another example, the BS may not receive a result from the first UE indicating whether the first LBT operation is successful, and then the LBT type of the second LBT operation indicated by the second DCI is LBT Cat4.

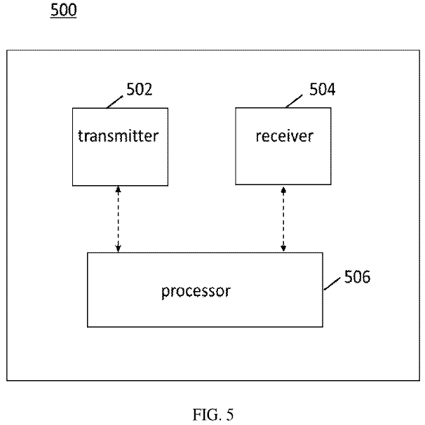

FIG. 5 illustrates a simplified block diagram of an exemplary apparatus 500 for SL transmission on unlicensed spectrum according to some embodiments of the present application. In some embodiments, the apparatus 500 may be or include at least part of a UE (e.g., UE 101a or UE 101b in FIG. 1). In some other embodiments, the apparatus 500 may be or include at least part of a BS (e.g., BS 102 in FIG. 1).

Referring to FIG. 5, the apparatus 500 may include at least one transmitter 502, at least one receiver 504, and at least one processor 506. The at least one transmitter 502 is coupled to the at least one processor 506, and the at least one receiver 504 is coupled to the at least one processor 506.

Although in this figure, elements such as the transmitter 502, the receiver 504, and the processor 506 are illustrated in the singular, the plural is contemplated unless a limitation to the singular is explicitly stated. In some embodiments of the present application, the transmitter 502 and the receiver 504 may be combined to one device, such as a transceiver. In some embodiments of the present application, the apparatus 500 may further include an input device, a memory, and/or other components. The transmitter 502, the receiver 504, and the processor 506 may be configured to perform any of the methods described herein (e.g., the method described with respect to FIGS. 2-4).

According to some embodiments of the present application, the apparatus 500 may be a UE (e.g., a Tx UE or a first UE), and the transmitter 502, the receiver 504, and the processor 506 may be configured to perform operations of the method as described with respect to FIG. 2. For example, the processor 506 may be configured to: determine an LBT type of a first LBT operation for an SL transmission on an unlicensed spectrum; and perform the first LBT operation. The transmitter 502 may be configured to transmit first information associated with the first LBT operation in SCI when the first LBT operation is successful. In an embodiment, the receiver 504 may be configured to receive DCI scheduling the SL transmission. In an embodiment, the transmitter 502 may be further configured to transmit a result of the first LBT operation based on an indication included in the DCI. In an embodiment, the receiver 504 may be configured to receive, from a second UE, information associated with a second LBT operation performed by the second UE.

According to some embodiments of the present application, the apparatus 500 may be a BS, and the transmitter 502, the receiver 504, and the processor 506 may be configured to perform operations of the method as described with respect to FIG. 4. For example, the transmitter 502 may be configured to transmit, to a UE, first DCI scheduling a first SL transmission on an unlicensed spectrum, wherein the first DCI includes a first indication indicating an LBT type of a first LBT operation for the first SL transmission.

In some embodiments of the present application, the apparatus 500 may further include at least one non-transitory computer-readable medium. In some embodiments of the present disclosure, the non-transitory computer-readable medium may have stored thereon computer-executable instructions to cause the processor 506 to implement any of the methods as described above. For example, the computer-executable instructions, when executed, may cause the processor 506 to interact with the transmitter 502 and/or the receiver 504, so as to perform operations of the methods, e.g., as described with respect to FIGS. 2-4.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for SL transmission on unlicensed spectrum, including a processor and a memory. Computer programmable instructions for implementing a method for SL transmission on unlicensed spectrum are stored in the memory, and the processor is configured to perform the computer programmable instructions to implement the method for SL transmission on unlicensed spectrum. The method for SL transmission on unlicensed spectrum may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SL transmission on unlicensed spectrum according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

What is claimed is:

1. A first user equipment (UE) for wireless communication, comprising:
at least one memory; and
at least one processor coupled with the at least one memory and configured to cause the first UE to:
determine a listen before talk (LBT) type of a first LBT operation for a sidelink (SL) transmission on an unlicensed spectrum;
perform the first LBT operation; and
transmit first information associated with the first LBT operation in sidelink control information (SCI) when the first LBT operation is successful.

2. The first UE of claim 1, wherein the first information associated with the first LBT operation indicates at least one of:
the LBT type of the first LBT operation; or
a remaining channel occupancy time (COT) associated with the first LBT operation.

3. The first UE of claim 1, wherein the at least one processor is configured to cause the first UE to receive downlink control information (DCI) scheduling the SL transmission, and determine the LBT type of the first LBT operation based at least in part on the DCI.

4. The first UE of claim 3, wherein the DCI includes a first indication indicating an LBT type for the first UE.

5. The first UE of claim 4, wherein the DCI further includes a second indication indicating the first UE to determine the LBT type of the first LBT operation based on the first indication or based on a determination by the first UE.

6. The first UE of claim 3, wherein the DCI includes an indication indicating the first UE to report a result of the first LBT operation regarding whether the first LBT operation is successful or not.

7. The first UE of claim 3, wherein the DCI includes an indication indicating a physical uplink control channel (PUCCH) resource for the first UE to report a result of the first LBT operation regarding whether the first LBT operation is successful or not, and
wherein the at least one processor is further configured to cause the first UE to transmit the result of the first LBT operation based on the indication.

8. The first UE of claim 7, wherein the indication indicates a time gap between a time slot in which the DCI is received and a time slot for reporting the result of the first LBT operation, or a time gap between a time slot in which the SL transmission is performed and a time slot for reporting the result of the first LBT operation.

9. The first UE of claim 7,
wherein the at least one processor is further configured to cause the first UE to obtain configuration information configured or pre-configured to the first UE, the configuration information includes one or more configurations, and each configuration indicates an offset from a time slot in which the DCI is received to a time slot for reporting the result of the first LBT operation, or an offset from a time slot in which the SL transmission is performed to a time slot for reporting the result of the first LBT operation; and
wherein the indication indicates one configuration of the one or more configurations.

10. The first UE of claim 3, wherein the at least one processor is further configured to cause the first UE to transmit an indication in a PUCCH resource for state reporting associated with the SL transmission, and wherein the indication indicates one or more of a result of the first LBT operation regarding whether the first LBT operation is successful or not or a feedback for the SL transmission.

11. The first UE of claim 1, wherein the at least one processor is configured to cause the first UE to:
receive, from a second UE, second information associated with a second LBT operation performed by the second UE, wherein the second information associated with the second LBT operation indicates at least one of:
an LBT type of the second LBT operation; or
a remaining channel occupancy time (COT) associated with the second LBT operation; and
determine the LBT type of the first LBT operation based at least in part on the second information.

12. The first UE of claim 11, wherein in a case that an LBT type indicated by a first indication included in DCI scheduling the SL transmission is LBT category 4 and a second indication included in the DCI indicates that the first UE is to determine the LBT type of the first LBT operation based on a determination by the first UE, the at least one processor is configured to cause the first UE to one or more of:
determine the LBT type of the first LBT operation to be LBT category 2 in response to one or more of the LBT type of the second LBT operation being LBT category 4 or the remaining COT associated with the second LBT operation being larger than 0; or
determine the LBT type of the first LBT operation to be LBT category 4 in response to one or more of no received information indicating that an LBT type of an LBT operation performed by another UE is LBT category 4 or no received information indicating that a remaining COT associated with an LBT operation performed by another UE is larger than 0.

13. The first UE of claim 11, wherein the at least one processor is configured to cause the first UE to one or more of:
determine the LBT type of the first LBT operation to be LBT category 2 in response to one or more of the LBT type of the second LBT operation being LBT category 4 or the remaining COT associated with the second LBT operation being larger than 0; or
determine the LBT type of the first LBT operation to be LBT category 4 in response to one o more of no received information indicating that an LBT type of an LBT operation performed by another UE is LBT category 4 or no received information indicating that a remaining COT associated with an LBT operation performed by another UE is larger than 0.

14. A base station for wireless communication, comprising:
at least one memory; and
at least one processor coupled with the at least one memory and configured to cause the base station to:
transmit, to a user equipment (UE), first downlink control information (DCI) scheduling a first sidelink (SL) transmission on an unlicensed spectrum, wherein the first DCI includes a first indication indicating a listen before talk (LBT) type of a first LBT operation for the first SL transmission.

15. A method performed by a user equipment (UE), comprising:
determining a listen before talk (LBT) type of an LBT operation for a sidelink (SL) transmission on an unlicensed spectrum;
performing the LBT operation; and
transmitting information associated with the LBT operation in sidelink control information (SCI) when the LBT operation is successful.

16. A processor for wireless communication, comprising:
at least one controller coupled with at least one memory and configured to cause the processor to:
determine a listen before talk (LBT) type of a first LBT operation for a sidelink (SL) transmission on an unlicensed spectrum;
perform the first LBT operation; and
transmit first information associated with the first LBT operation in sidelink control information (SCI) when the first LBT operation is successful.

17. The processor of claim 16, wherein the first information associated with the first LBT operation indicates at least one of:
the LBT type of the first LBT operation; or
a remaining channel occupancy time (COT) associated with the first LBT operation.

18. The processor of claim 16, wherein the at least one controller is configured to cause the processor to receive downlink control information (DCI) scheduling the SL transmission, and determine the LBT type of the first LBT operation based at least in part on the DCI.

19. The processor of claim 18, wherein the DCI includes a first indication indicating an LBT type for the processor.

20. The processor of claim 19, wherein the DCI further includes a second indication indicating the processor to determine the LBT type of the first LBT operation based on the first indication or based on a determination by the processor.
